(19) United States
(12) Patent Application Publication
(10) Pub. No.: US 2014/0197700 A1
(43) Pub. Date: Jul. 17, 2014

(54) ROTOR

(71) Applicant: BIGBEST SOLUTIONS, INC., Taichung City (TW)

(72) Inventors: Chao-Pi CHANG, Nantou County (TW); Jia-Yuan LIANG, Nantou City (TW)

(21) Appl. No.: 14/150,948

(22) Filed: Jan. 9, 2014

(30) Foreign Application Priority Data
Jan. 11, 2013 (TW) 102101130

(51) Int. Cl. H02K 1/27

(52) U.S. Cl. CPC H02K 1/2706
USPC 310/43

(57) ABSTRACT

A rotor includes an axle, a back iron unit, a magnet unit and an adhesive layer. The back iron unit includes annular inner and outer components, and a plurality of plastic components. The inner component is made from a non-metal material and is sleeved on the axle. The outer component is made from a magnetically permeable metal material and surrounds the inner component. The plastic components protrude from an outer surface of the outer component. The magnet unit has a cavity for receiving the back iron unit. The plastic components abut against a cavity-defining surface of the magnet unit that defines the cavity. The adhesive layer is formed in a space between the back iron unit and the magnet unit.

### CROSS-REFERENCE TO RELATED APPLICATION

This application claims priority of Taiwanese Patent Application No. 102101130, filed on Jan. 11, 2013.

### BACKGROUND OF THE INVENTION

1. Field of the Invention

The invention relates to a rotor, more particularly to a rotor that is quiet and that provides an enhanced magnetic flux.

2. Description of the Related Art

Referring to FIG. 1, a conventional rotor 10 includes an axle 11, an annular inner component 12 sleeved on the axle 11, and a magnetic member 13 sleeved on the inner component 12. The inner component 12 is made of a non-metal plastic material and is formed with a plurality of holes 121 that are angularly spaced from one another. The use of the material and design of the inner component 12 blocks the noise of vibration from cogging torque during rotation of the conventional rotor 10, thus achieving noise reduction effect.

However, during rotation of the conventional rotor 10, the magnetic lines of force between the axle 11 and the magnetic member 13 is weakened due to the plastic insulating material of the inner component 12, causing poor magnetic flux.

### SUMMARY OF THE INVENTION

Therefore, the object of the present invention is to provide a rotor that can eliminate the aforesaid drawbacks of the prior art.

According to the pre sent invention, there is provided a rotor including an axle, a back iron unit, a magnet unit and an adhesive layer. The back iron unit includes an annular inner component, an annular outer component and a plurality of plastic components. The annular inner component is made from a non-metal material and is sleeved on the axle. The annular outer component is made from a magnetically permeable metal material and surrounds the inner component. The plastic components protrude from an outer surface of the outer component. The magnet unit has a cavity for receiving the back iron unit. The plastic components abut against a cavity-defining surface of the magnet unit that defines the cavity. The adhesive layer is formed in a space between the back iron unit and the magnet unit.

### BRIEF DESCRIPTION OF THE DRAWINGS

Other features and advantages of the present invention will become apparent in the following detailed description of the preferred embodiment with reference to the accompanying drawings, of which:

FIG. 1 is fragmentary, partly cut-away perspective view of a conventional rotor;

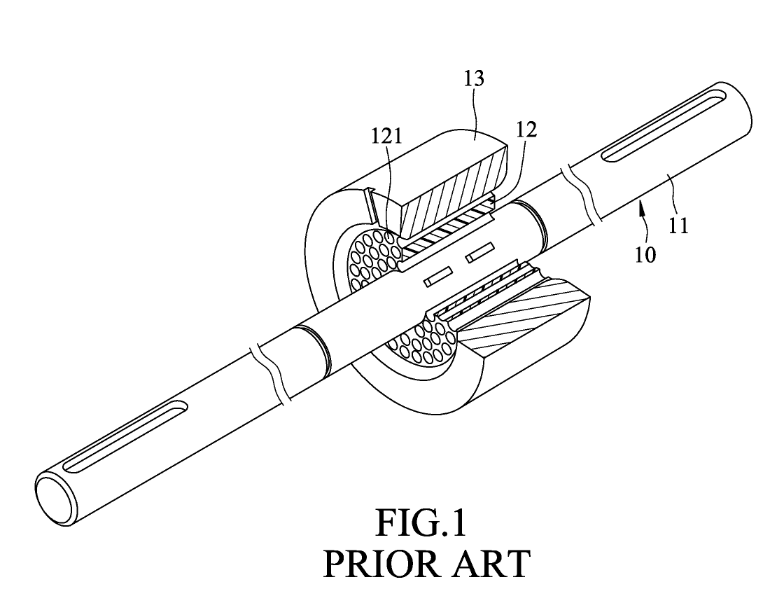

FIG. 2 is an assembled perspective view of the preferred embodiment of a rotor according to the present invention;

FIG. 3 is a fragmentary exploded perspective view of the preferred embodiment;

FIG. 4 is a front view of the preferred embodiment; and

FIG. 5 is a sectional side view of the preferred embodiment taken along line V-V of FIG. 4.

### DETAILED DESCRIPTION OF THE PREFERRED EMBODIMENT

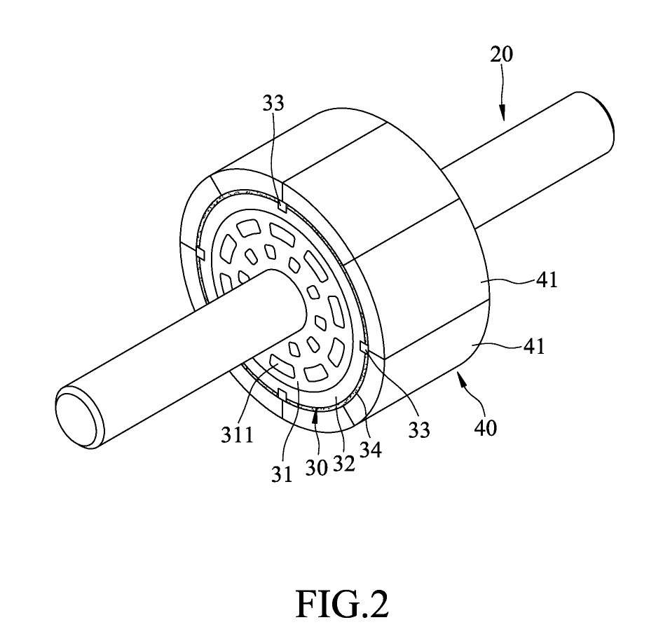

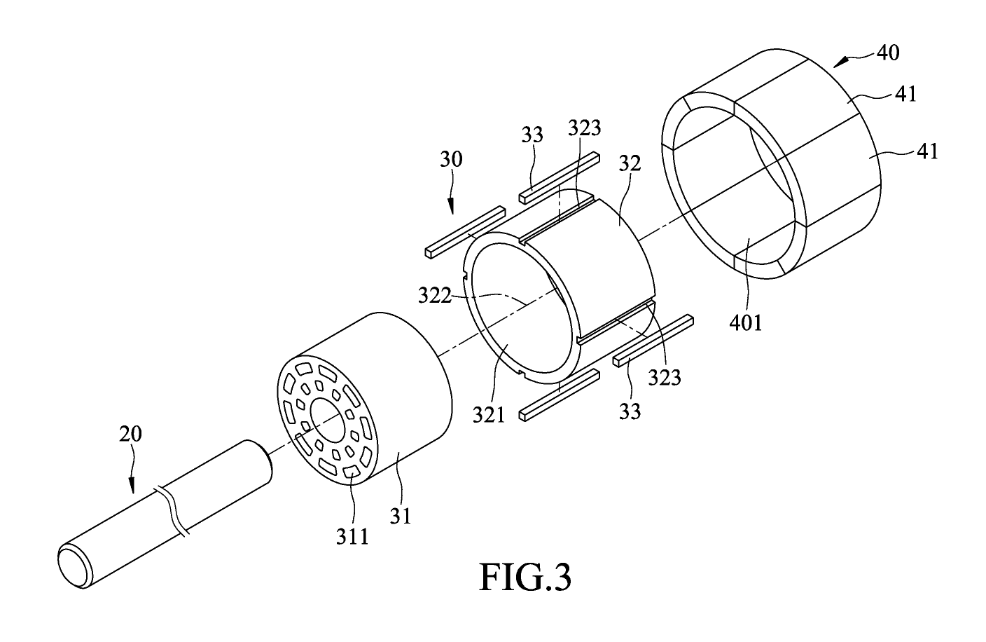

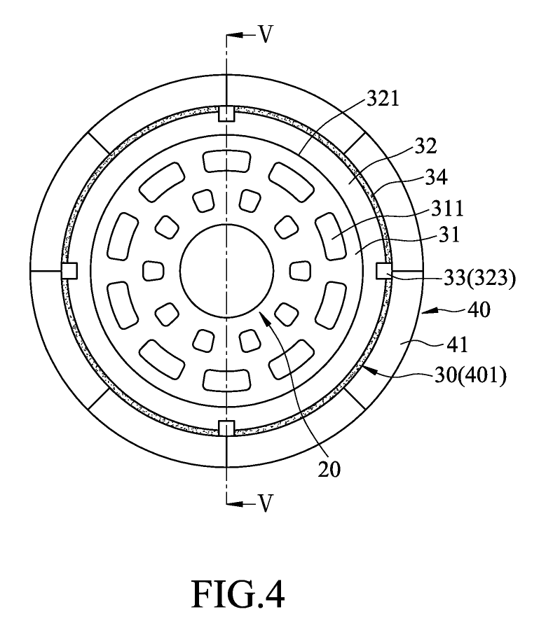

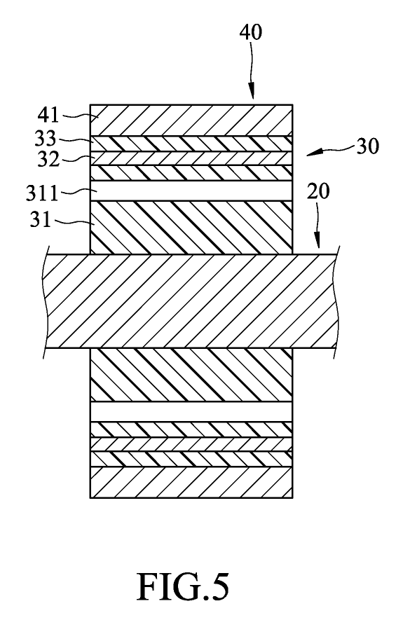

Referring to FIGS. 2 to 5, the preferred embodiment of a rotor according to the present invention includes an axle 20, a back iron unit 30, an adhesive layer 34 and a magnet unit 40.

The axle 20 is an elongated shaft made from a metal material and has two ends that can each be set into a ball bearing (not shown). Since the axle 20 is known to those skilled in the art, further details will be omitted herein.

The back iron unit 30 includes an annular inner component 31 sleeved on the axle 20, an annular outer component 32 surrounding the inner component 31, and a plurality of plastic components 33 protruding from an outer surface of the outer component 32 and symmetrically disposed therearound.

The inner component 31 is made from a non-metal material, and is made from a plastic material in this embodiment. During manufacture, the inner component 31 can be integrated with the axle 20 as one piece through injection molding. The inner component 31 is formed with a plurality of holes 311 that are annularly and radially arranged and each of which is fan-shaped. The sides of the holes 311 vary in the radial direction.

The outer component 32 is made from a magnetically permeable metal material and is formed with a through hole 321 for receiving the inner component 31. The through hole 321 has an axis 322. The inner component 31 can be combined with the outer component 32 in order to achieve an enhanced magnetic flux. The outer surface of the outer component 32 is formed with a plurality of embedding slots 323. Each of the plastic components 33 is secured in a respective one of the embedding slots 323. The plastic components 33 are symmetrically disposed around the outer component 32. During assembly of the outer component 32 and the magnet unit 40, the deforming ability of the plastic components 33 allows the magnet unit 40 to maintain good concentricity with the back iron unit 30. The adhesive layer 34 is formed in a space between the back iron unit 30 and the magnet unit 40.

The magnet unit 40 is an annular body formed by a plurality of N-pole and S-pole magnets 41 that are alternately arranged, and is formed with a cavity 401 for receiving the back iron unit 30. The plastic components 33 abut against a cavity-defining surface of the magnet unit 40 that defines the cavity 401 and the adhesive layer 34 fixedly adheres the magnet unit 40 to the back iron unit 30.

The effects that the present invention manages to achieve is mainly due to the structure of the back iron unit 30, which is composed of the inner and outer components 31, 32, and thus, the main characteristics of the present invention are as follows.

By using the non-metal plastic material in the inner component 31, (1) harmonics of waves (surge) are reduced, (2) occurrence of resonance is reduced, and (3) galvanic corrosion is prevented from reaching the ball bearings through the axle 20. In addition, the inner component 31 and the axle 20 can be integrated into a one-piece structure through injection molding, thereby increasing/enhancing their concentricity and binding strength. The holes 311 of the inner component 31 not only reduce weight but also increase overall strength of the inner component 31. More importantly, the present invention is provided with the outer component 32 that surrounds the inner component 31 and that is made from a magnetically permeable metal material, which during rotation of the rotor, aids in maintaining a continuous magnetic line of force between the magnet unit 40 and the axle 20, thus enhancing the magnetic flux.

It is worth to mention that since the magnet unit 40 is bounded with the metal-made outer component 32, as opposed to the plastic-made inner component 31, the binding therebetween is stronger due to the relatively closer shrinkage coefficients of the metal material and the magnet material.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A rotor comprising:
an axle;
a back iron unit including an annular inner component that is made from a non-metal material, and that is sleeved on said axle, an annular outer component that is made from a magnetically permeable metal material and that surrounds said inner component, and a plurality of plastic components protruding from an outer surface of said outer component;
a magnet unit having a cavity for receiving said back iron unit, said plastic components abutting against a cavity-defining surface of said magnet unit that defines said cavity; and
an adhesive layer formed in a space between said back iron unit and said magnet unit.

2. The rotor as claimed in claim 1, wherein said inner component is formed with a plurality of holes, which are annularly and radially arranged and each of which is fan-shaped.

3. The rotor as claimed in claim 1, wherein the outer surface of said outer component of said back iron unit is formed with a plurality of embedding slots, each of said plastic components being secured in a respective one of said embedding slots.

4. The rotor as claimed in claim 1, wherein the plastic components are symmetrically disposed around said outer component.
